(19) United States
(12) Patent Application Publication
(10) Pub. No.: US 2024/0062466 A1
(43) Pub. Date: Feb. 22, 2024

(54) POINT CLOUD OPTIMIZATION USING INSTANCE SEGMENTATION

(71) Applicant: Tencent America LLC, Palo Alto, CA (US)

(72) Inventors: Ethan SCHUR, San Jose, CA (US); Xiaozhong XU, State College, PA (US); Shan LIU, San Jose, CA (US); Xiang ZHANG, Sunnyvale, CA (US)

(73) Assignee: Tencent America LLC, Palo Alto, CA (US)

(21) Appl. No.: 18/207,614

(22) Filed: Jun. 8, 2023

Related U.S. Application Data
(60) Provisional application No. 63/398,669, filed on Aug. 17, 2022.

(51) Int. Cl. G06T 17/20

(52) U.S. Cl. CPC G06T 17/20

(57) ABSTRACT

Aspects of the disclosure provide methods and apparatuses for point cloud processing. In some examples, an apparatus for point cloud processing includes processing circuitry. For example, the processing circuitry obtains point cloud data corresponding to a point cloud in a three dimensional (3D) space, projects the point cloud in the 3D space to one or more two dimensional (2D) planes to generate one or more images. The processing circuitry generates a pixel wise mask for object instances in the point cloud according to the one or more images. The pixel wise mask includes first pixels that are associated with a first object instance in the point cloud. The processing circuitry processes the point cloud based on the pixel wise mask, a portion of the point cloud corresponding the first pixels in the pixel wise mask is processed based on one or more processing parameters determined for the first object instance.

### INCORPORATION BY REFERENCE

This present application claims the benefit of priority to U.S. Provisional Application No. 63/398,669, “Point Cloud optimization using instance segmentation” filed on Aug. 17, 2022. The entire disclosure of the prior application is hereby incorporated by reference in its entirety.

### TECHNICAL FIELD

The present disclosure describes embodiments generally related to point cloud processing.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Various technologies are developed to capture and represent the world, such as objects in the world, environments in the world, and the like in 3-dimensional (3D) space as well as humans and animals. 3D representations of the world can enable more immersive forms of interaction and communication. In some examples, point clouds and meshes can be used as 3D representations of the world.

### SUMMARY

Aspects of the disclosure provide methods and apparatuses for point cloud processing. In some examples, an apparatus for point cloud processing includes processing circuitry. For example, the processing circuitry obtains point cloud data corresponding to a point cloud in a three dimensional (3D) space, projects the point cloud in the 3D space to one or more two dimensional (2D) planes to generate one or more images. The processing circuitry generates a pixel wise mask for object instances in the point cloud according to the one or more images. The pixel wise mask includes first pixels that are associated with a first object instance in the point cloud. The processing circuitry processes the point cloud based on the pixel wise mask, a portion of the point cloud corresponding the first pixels in the pixel wise mask is processed based on one or more processing parameters determined for the first object instance.

In some examples, the one or more images are input into a convolutional neural network model that is trained to generate pixel wise masks for object instances. In some examples, the one or more images are input into a non neural network based logic model that is configured to generate pixel wise masks for object instances.

In some examples, the point cloud includes points representing a person. The processing circuitry generates the pixel wise mask that includes a plurality of sub masks respectively associated with facial elements and body elements of the person.

In some examples, the processing circuitry determines respective parameters of one or more virtual cameras associated with the one or more 2D planes for a projection of the point cloud according to pretrained data.

In some examples, the processing circuitry determines first parameters for voxelating the first object instance, and voxelates the portion of the point cloud corresponding the first pixels in the pixel wise mask according to the first parameters.

In some examples, the processing circuitry generates a scene graph associated with the point cloud based on the pixel wise mask, the scene graph includes at least a first scene element for the first object instance.

In some examples, the processing circuitry processes the point cloud with the pixel wise mask by a video based point cloud compression (V-PCC) scheme. In an example, the processing circuitry divides the point cloud into a plurality of segments according to the pixel wise mask having a plurality of sub masks corresponding to the plurality of segments. Further, the processing circuitry packs the plurality of segments respectively into geometry maps and encodes the geometry maps into respective sub streams. In another example, the processing circuitry generates 2D patches respectively for the plurality of segments based on the pixel wise mask, a 2D patch for a segment includes geometry information and semantic information of the 2D patch. In another example, the processing circuitry determines a quantization parameter for encoding the portion of the point cloud based on the pixel wise mask.

In some examples, the processing circuitry processes the point cloud with the pixel wise mask by a geometry based point cloud compression (G-PCC) scheme. In an example, the processing circuitry divides the point cloud into multiple slices based on the pixel wise mask, determines encoder parameters respectively for the multiple slices based on respective characteristics, and encodes respectively the multiple slices into respective sub streams based on the encoder parameters. In another example, the processing circuitry determines geometry quantization parameters for octree partitioning based on the pixel wise mask, and performs the octree partitioning based on the geometry quantization parameters.

Aspects of the disclosure also provide a non-transitory computer-readable medium storing instructions which when executed by a computer cause the computer to perform any one or a combination of the methods for point cloud processing.

### BRIEF DESCRIPTION OF THE DRAWINGS

Further features, the nature, and various advantages of the disclosed subject matter will be more apparent from the following detailed description and the accompanying drawings in which:

FIG. 1 shows a block diagram of a communication system in some examples.

FIG. 2 shows a block diagram of a streaming system in some examples.

FIG. 3 shows a block diagram of an encoder for encoding point cloud frames in some examples.

FIG. 4 shows a block diagram of a decoder for decoding a compressed bitstream corresponding to point cloud frames in some examples.

FIG. 5 shows a block diagram of a video decoder in some examples.

FIG. 6 shows a block diagram of a video encoder in some examples.

FIG. 7 shows a block diagram of an encoder for encoding point cloud frames in some examples.

FIG. 8 shows a block diagram of a decoder for decoding a compressed bitstream carrying point cloud frames in some examples.

FIG. 9 shows a diagram of a computer system according to an embodiment of the disclosure.

FIG. 10 shows a diagram for generating multiple virtual camera views in some examples.

FIG. 11 shows an example of a pixel wise mask in some examples.

FIG. 12 shows a diagram of voxelization in some examples.

FIG. 13 shows a flow chart outlining a process example in some examples.

FIG. 14 is a schematic illustration of a computer system in some examples.

### DETAILED DESCRIPTION OF EMBODIMENTS

Aspects of the disclosure provide techniques in the field of three dimensional (3D) media processing.

Technology developments in 3D media processing, such as advances in three dimensional (3D) capture, 3D modeling, and 3D rendering, and the like have promoted the ubiquitous presence of 3D media contents across several platforms and devices. In an example, a baby's first step can be captured in one continent, media technology can allow grandparents to view (and maybe interact) and enjoy an immersive experience with the baby in another continent. According to an aspect of the disclosure, in order to improve immersive experience, 3D models are becoming ever more sophisticated, and the creation and consumption of 3D models occupy a significant amount of data resources, such as data storage, data transmission resources.

According to some aspects of the disclosure, point clouds and meshes can be used as 3D models to represent immersive contents.

A point cloud generally may refer to a set of points in a 3D space, each with associated attributes, such as color, material properties, texture information, intensity attributes, reflectivity attributes, motion related attributes, modality attributes, and various other attributes. Point clouds can be used to reconstruct an object or a scene as a composition of such points.

A mesh (also referred to as mesh model) of an object can include polygons that describe the surface of the object. Each polygon can be defined by vertices of the polygon in 3D space and the information of how the vertices are connected into the polygon. The information of how the vertices are connected is referred to as connectivity information. In some examples, the mesh can also include attributes, such as color, normal, and the like, associated with the vertices. According to some aspects of the disclosure, some coding tools for point cloud compression (PCC) can be used for mesh compression.

Point clouds can be used to reconstruct an object or a scene as a composition of points. The points can be captured using multiple cameras, depth sensors or Lidar in various setups and may be made up of thousands up to billions of points in order to realistically represent reconstructed scenes or objects. A patch generally may refer to a contiguous subset of the surface described by the point cloud. In an example, a patch includes points with surface normal vectors that deviate from one another less than a threshold amount.

PCC can be performed according to various schemes, such as a geometry-based scheme that is referred to as G-PCC, a video coding based scheme that is referred to as V-PCC, and the like. According to some aspects of the disclosure, the G-PCC encodes the 3D geometry directly and is a purely geometry-based approach without much to share with video coding, and the V-PCC is heavily based on video coding. For example, V-PCC can map a point of the 3D cloud to a pixel of a 2D grid (an image). The V-PCC scheme can utilize generic video codecs for point cloud compression. A PCC codec (encoder/decoder) in the present disclosure can be G-PCC codec (encoder/decoder) or V-PCC codec.

According to an aspect of the disclosure, the V-PCC scheme can use existing video codecs to compress the geometry, occupancy, and texture of a point cloud as three separate video sequences. The extra metadata needed to interpret the three video sequences is compressed separately. A small portion of the overall bitstream is the metadata, which could be encoded/decoded efficiently using software implementation in an example. The bulk of the information is handled by the video codec.

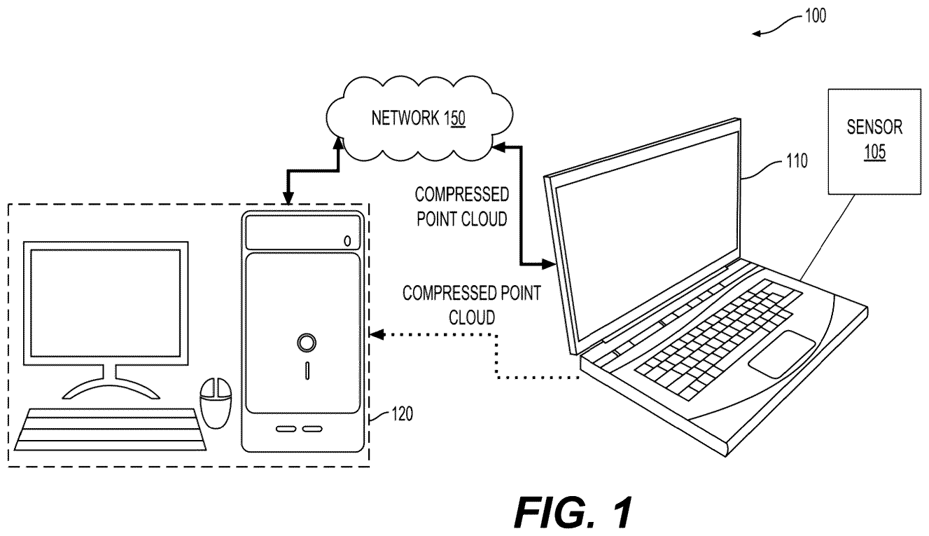

FIG. 1 illustrates a block diagram of a communication system (100) in some examples. The communication system (100) includes a plurality of terminal devices that can communicate with each other, via, for example, a network (150). For example, the communication system (100) includes a pair of terminal devices (110) and (120) interconnected via the network (150). In the FIG. 1 example, the first pair of terminal devices (110) and (120) may perform unidirectional transmission of point cloud data. For example, the terminal device (110) may compress a point cloud (e.g., points representing a structure) that is captured by a sensor (105) connected with the terminal device (110). The compressed point cloud can be transmitted, for example in the form of a bitstream, to the other terminal device (120) via the network (150). The terminal device (120) may receive the compressed point cloud from the network (150), decompress the bitstream to reconstruct the point cloud, and suitably display the reconstructed point cloud. Unidirectional data transmission may be common in media serving applications and the like.

In the FIG. 1 example, the terminal devices (110) and (120) may be illustrated as servers, and personal computers, but the principles of the present disclosure may be not so limited. Embodiments of the present disclosure find application with laptop computers, tablet computers, smart phones, gaming terminals, media players, and/or dedicated three-dimensional (3D) equipment. The network (150) represents any number of networks that transmit compressed point cloud between the terminal devices (110) and (120). The network (150) can include for example wireline (wired) and/or wireless communication networks. The network (150) may exchange data in circuit-switched and/or packet-switched channels. Representative networks include telecommunications networks, local area networks, wide area networks, the Internet, and the like.

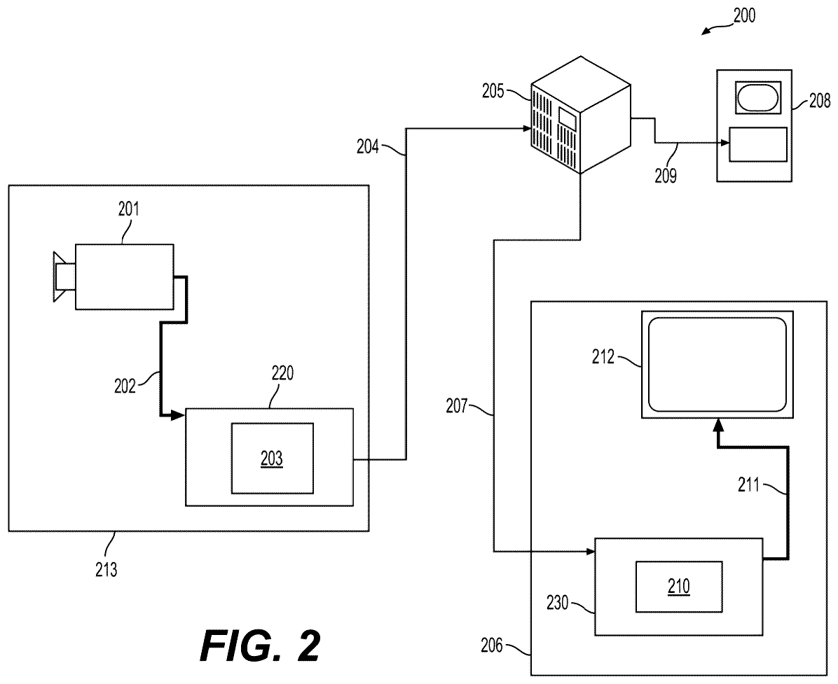

FIG. 2 illustrates a block diagram of a streaming system (200) in some examples. The streaming system (200) is a use application of point cloud. The disclosed subject matter can be equally applicable to other point cloud enabled applications, such as, 3D telepresence application, virtual reality application, and the like.

The streaming system (200) may include a capture subsystem (213). The capture subsystem (213) can include a point cloud source (201), for example light detection and ranging (LIDAR) systems, 3D cameras, 3D scanners, a graphics generation component that generates the uncompressed point cloud in software, and the like that generates for example point clouds (202) that are uncompressed. In an example, the point clouds (202) include points that are captured by the 3D cameras. The point clouds (202), depicted as a bold line to emphasize a high data volume when compared to compressed point clouds (204) (a bitstream of compressed point clouds). The compressed point clouds (204) can be generated by an electronic device (220) that includes an encoder (203) coupled to the point cloud source (201). The encoder (203) can include hardware, software, or a combination thereof to enable or implement aspects of the disclosed subject matter as described in more detail below. The compressed point clouds (204) (or bitstream of compressed point clouds (204)), depicted as a thin line to emphasize the lower data volume when compared to the stream of point clouds (202), can be stored on a streaming server (205) for future use. One or more streaming client subsystems, such as client subsystems (206) and (208) in FIG. 2 can access the streaming server (205) to retrieve copies (207) and (209) of the compressed point cloud (204). A client subsystem (206) can include a decoder (210), for example, in an electronic device (230). The decoder (210) decodes the incoming copy (207) of the compressed point clouds and creates an outgoing stream of reconstructed point clouds (211) that can be rendered on a rendering device (212).

It is noted that the electronic devices (220) and (230) can include other components (not shown). For example, the electronic device (220) can include a decoder (not shown) and the electronic device (230) can include an encoder (not shown) as well.

In some streaming systems, the compressed point clouds (204), (207), and (209) (e.g., bitstreams of compressed point clouds) can be compressed according to certain standards. In some examples, video coding standards are used in the compression of point clouds. Examples of those standards include, High Efficiency Video Coding (HEVC), Versatile Video Coding (VVC), and the like.

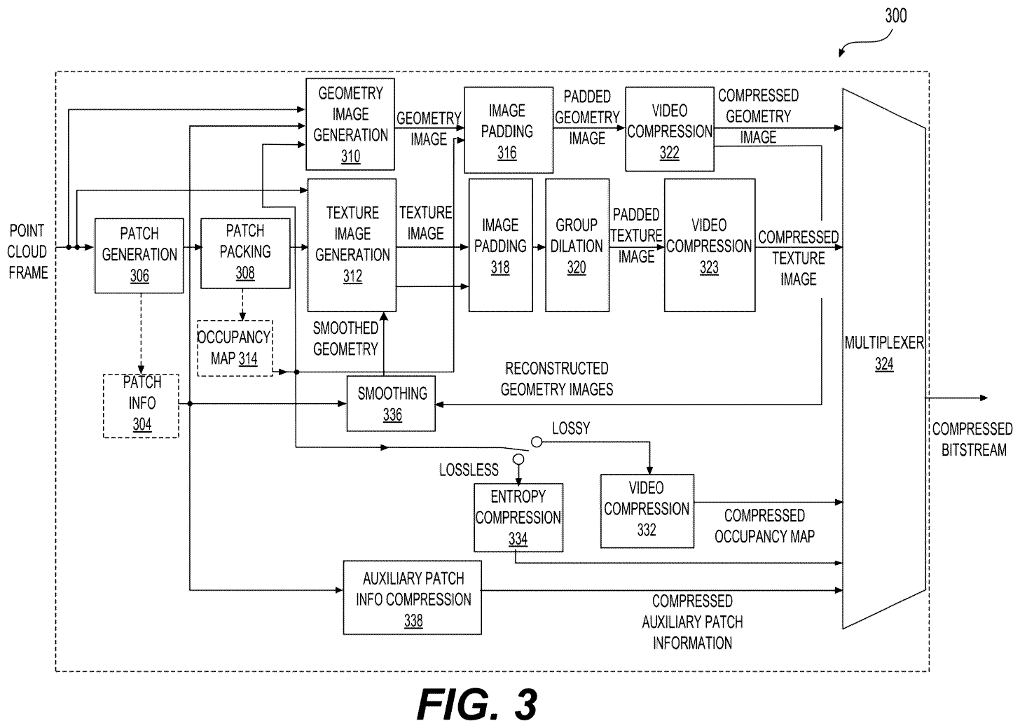

FIG. 3 shows a block diagram of a V-PCC encoder (300) for encoding point cloud frames, according to some embodiments. In some embodiments, the V-PCC encoder (300) can be used in the communication system (100) and streaming system (200). For example, the encoder (203) can be configured and operate in a similar manner as the V-PCC encoder (300).

The V-PCC encoder (300) receives point cloud frames as uncompressed inputs and generates bitstream corresponding to compressed point cloud frames. In some embodiments, the V-PCC encoder (300) may receive the point cloud frames from a point cloud source, such as the point cloud source (201) and the like.

In the FIG. 3 example, the V-PCC encoder (300) includes a patch generation module (306), a patch packing module (308), a geometry image generation module (310), a texture image generation module (312), a patch info module (304), an occupancy map module (314), a smoothing module (336), image padding modules (316) and (318), a group dilation module (320), video compression modules (322), (323) and (332), an auxiliary patch info compression module (338), an entropy compression module (334), and a multiplexer (324).

According to an aspect of the disclosure, the V-PCC encoder (300), converts 3D point cloud frames into image-based representations along with some metadata (e.g., occupancy map and patch info) that is used to convert the compressed point cloud back into a decompressed point cloud. In some examples, the V-PCC encoder (300) can convert 3D point cloud frames into geometry images, texture images and occupancy maps, and then use video coding techniques to encode the geometry images, texture images and occupancy maps into a bitstream. Generally, a geometry image is a 2D image with pixels filled with geometry values associated with points projected to the pixels, and a pixel filled with a geometry value can be referred to as a geometry sample. A texture image is a 2D image with pixels filled with texture values associated with points projected to the pixels, and a pixel filled with a texture value can be referred to as a texture sample. An occupancy map is a 2D image with pixels filled with values that indicate occupied or unoccupied by patches.

The patch generation module (306) segments a point cloud into a set of patches (e.g., a patch is defined as a contiguous subset of the surface described by the point cloud), which may be overlapping or not, such that each patch may be described by a depth field with respect to a plane in 2D space. In some embodiments, the patch generation module (306) aims at decomposing the point cloud into a minimum number of patches with smooth boundaries, while also minimizing the reconstruction error.

In some examples, the patch info module (304) can collect the patch information that indicates sizes and shapes of the patches. In some examples, the patch information can be packed into an image frame and then encoded by the auxiliary patch info compression module (338) to generate the compressed auxiliary patch information.

In some examples, the patch packing module (308) is configured to map the extracted patches onto a 2 dimensional (2D) grid while minimize the unused space and guarantee that every M×M (e.g., 16×16) block of the grid is associated with a unique patch. Efficient patch packing can directly impact the compression efficiency either by minimizing the unused space or ensuring temporal consistency.

The geometry image generation module (310) can generate 2D geometry images associated with geometry of the point cloud at given patch locations. The texture image generation module (312) can generate 2D texture images associated with texture of the point cloud at given patch locations. The geometry image generation module (310) and the texture image generation module (312) exploit the 3D to 2D mapping computed during the packing process to store the geometry and texture of the point cloud as images. In order to better handle the case of multiple points being projected to the same sample, each patch is projected onto two images, referred to as layers. In an example, geometry image is represented by a monochromatic frame of W×H in YUV420-8 bit format. To generate the texture image, the texture generation procedure exploits the reconstructed/smoothed geometry in order to compute the colors to be associated with the re-sampled points.

The occupancy map module (314) can generate an occupancy map that describes padding information at each unit. For example, the occupancy image includes a binary map that indicates for each cell of the grid whether the cell belongs to the empty space or to the point cloud. In an example, the occupancy map uses binary information describing for each pixel whether the pixel is padded or not. In another example, the occupancy map uses binary information describing for each block of pixels whether the block of pixels is padded or not.

The occupancy map generated by the occupancy map module (314) can be compressed using lossless coding or lossy coding. When lossless coding is used, the entropy compression module (334) is used to compress the occupancy map. When lossy coding is used, the video compression module (332) is used to compress the occupancy map.

It is noted that the patch packing module (308) may leave some empty spaces between 2D patches packed in an image frame. The image padding modules (316) and (318) can fill the empty spaces (referred to as padding) in order to generate an image frame that may be suited for 2D video and image codecs. The image padding is also referred to as background filling which can fill the unused space with redundant information. In some examples, a good background filling minimally increases the bit rate while does not introduce significant coding distortion around the patch boundaries.

The video compression modules (322), (323), and (332) can encode the 2D images, such as the padded geometry images, padded texture images, and occupancy maps based on a suitable video coding standard, such as HEVC, VVC and the like. In an example, the video compression modules (322), (323), and (332) are individual components that operate separately. It is noted that the video compression modules (322), (323), and (332) can be implemented as a single component in another example.

In some examples, the smoothing module (336) is configured to generate a smoothed image of the reconstructed geometry image. The smoothed image can be provided to the texture image generation (312). Then, the texture image generation (312) may adjust the generation of the texture image based on the reconstructed geometry images. For example, when a patch shape (e.g. geometry) is slightly distorted during encoding and decoding, the distortion may be taken into account when generating the texture images to correct for the distortion in patch shape.

In some embodiments, the group dilation (320) is configured to pad pixels around the object boundaries with redundant low-frequency content in order to improve coding gain as well as visual quality of reconstructed point cloud.

The multiplexer (324) can multiplex the compressed geometry image, the compressed texture image, the compressed occupancy map, the compressed auxiliary patch information into a compressed bitstream.

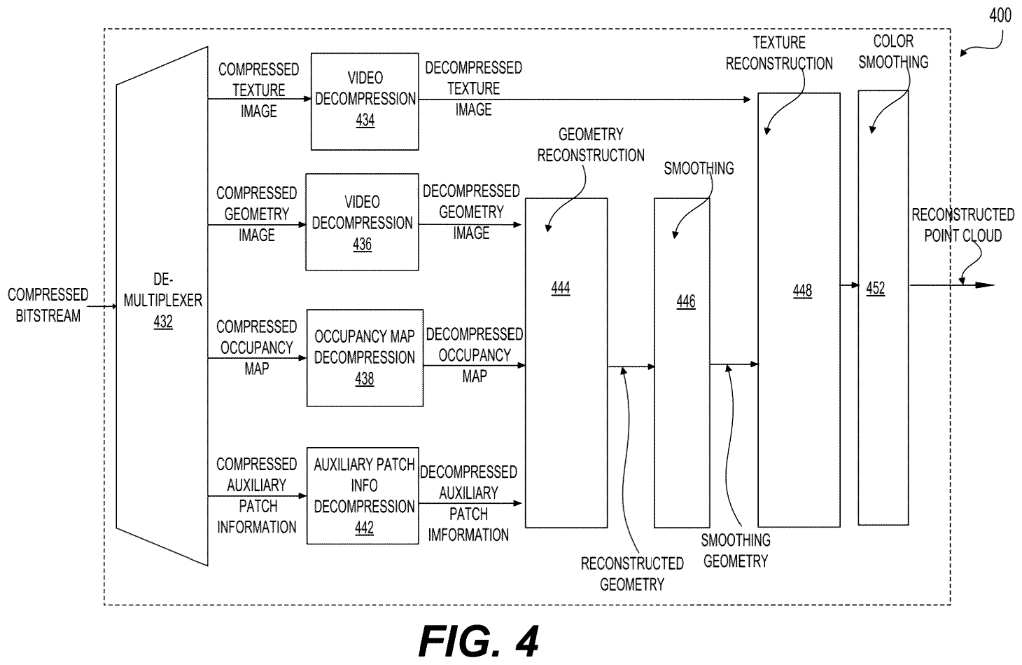

FIG. 4 shows a block diagram of a V-PCC decoder (400) for decoding compressed bitstream corresponding to point cloud frames, in some examples. In some examples, the V-PCC decoder (400) can be used in the communication system (100) and streaming system (200). For example, the decoder (210) can be configured to operate in a similar manner as the V-PCC decoder (400). The V-PCC decoder (400) receives the compressed bitstream, and generates reconstructed point cloud based on the compressed bitstream.

In the FIG. 4 example, the V-PCC decoder (400) includes a de-multiplexer (432), video decompression modules (434) and (436), an occupancy map decompression module (438), an auxiliary patch-information decompression module (442), a geometry reconstruction module (444), a smoothing module (446), a texture reconstruction module (448), and a color smoothing module (452).

The de-multiplexer (432) can receive and separate the compressed bitstream into compressed texture image, compressed geometry image, compressed occupancy map, and compressed auxiliary patch information.

The video decompression modules (434) and (436) can decode the compressed images according to a suitable standard (e.g., HEVC, VVC, etc.) and output decompressed images. For example, the video decompression module (434) decodes the compressed texture images and outputs decompressed texture images; and the video decompression module (436) decodes the compressed geometry images and outputs the decompressed geometry images.

The occupancy map decompression module (438) can decode the compressed occupancy maps according to a suitable standard (e.g., HEVC, VVC, etc.) and output decompressed occupancy maps.

The auxiliary patch-information decompression module (442) can decode the compressed auxiliary patch information according to a suitable standard (e.g., HEVC, VVC, etc.) and output decompressed auxiliary patch information.

The geometry reconstruction module (444) can receive the decompressed geometry images, and generate reconstructed point cloud geometry based on the decompressed occupancy map and decompressed auxiliary patch information.

The smoothing module (446) can smooth incongruences at edges of patches. The smoothing procedure aims at alleviating potential discontinuities that may arise at the patch boundaries due to compression artifacts. In some embodiments, a smoothing filter may be applied to the pixels located on the patch boundaries to alleviate the distortions that may be caused by the compression/decompression.

The texture reconstruction module (448) can determine texture information for points in the point cloud based on the decompressed texture images and the smoothing geometry.

The color smoothing module (452) can smooth incongruences of coloring. Non-neighboring patches in 3D space are often packed next to each other in 2D videos. In some examples, pixel values from non-neighboring patches might be mixed up by the block-based video codec. The goal of color smoothing is to reduce the visible artifacts that appear at patch boundaries.

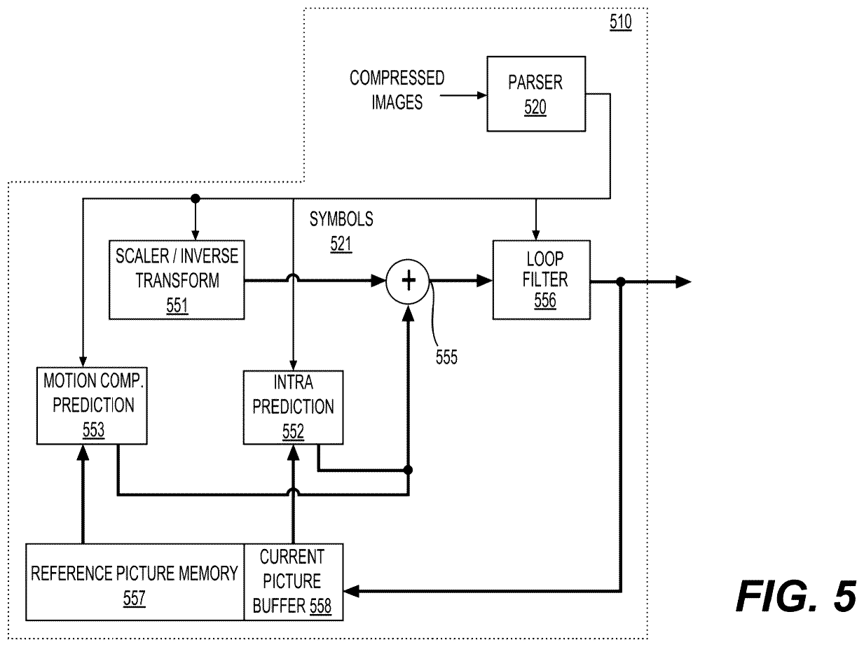

FIG. 5 shows a block diagram of a video decoder (510) in some examples. The video decoder (510) can be used in the V-PCC decoder (400). For example, the video decompression modules (434) and (436), the occupancy map decompression module (438) can be similarly configured as the video decoder (510).

The video decoder (510) may include a parser (520) to reconstruct symbols (521) from compressed images, such as the coded video sequence. Categories of those symbols include information used to manage operation of the video decoder (510). The parser (520) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (520) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (520) may also extract from the coded video sequence information such as transform coefficients, quantizer parameter values, motion vectors, and so forth.

The parser (520) may perform an entropy decoding/parsing operation on the video sequence received from a buffer memory, so as to create symbols (521).

Reconstruction of the symbols (521) can involve multiple different units depending on the type of the coded video picture or parts thereof (such as: inter and intra picture, inter and intra block), and other factors. Which units are involved, and how, can be controlled by the subgroup control information that was parsed from the coded video sequence by the parser (520). The flow of such subgroup control information between the parser (520) and the multiple units below is not depicted for clarity.

Beyond the functional blocks already mentioned, the video decoder (510) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (551). The scaler/inverse transform unit (551) receives a quantized transform coefficient as well as control information, including which transform to use, block size, quantization factor, quantization scaling matrices, etc. as symbol(s) (521) from the parser (520). The scaler/inverse transform unit (551) can output blocks comprising sample values that can be input into aggregator (555).

In some cases, the output samples of the scaler/inverse transform (551) can pertain to an intra coded block; that is: a block that is not using predictive information from previously reconstructed pictures, but can use predictive information from previously reconstructed parts of the current picture. Such predictive information can be provided by an intra picture prediction unit (552). In some cases, the intra picture prediction unit (552) generates a block of the same size and shape of the block under reconstruction, using surrounding already reconstructed information fetched from the current picture buffer (558). The current picture buffer (558) buffers, for example, partly reconstructed current picture and/or fully reconstructed current picture. The aggregator (555), in some cases, adds, on a per sample basis, the prediction information the intra prediction unit (552) has generated to the output sample information as provided by the scaler/inverse transform unit (551).

In other cases, the output samples of the scaler/inverse transform unit (551) can pertain to an inter coded, and potentially motion compensated block. In such a case, a motion compensation prediction unit (553) can access reference picture memory (557) to fetch samples used for prediction. After motion compensating the fetched samples in accordance with the symbols (521) pertaining to the block, these samples can be added by the aggregator (555) to the output of the scaler/inverse transform unit (551) (in this case called the residual samples or residual signal) so as to generate output sample information. The addresses within the reference picture memory (557) from where the motion compensation prediction unit (553) fetches prediction samples can be controlled by motion vectors, available to the motion compensation prediction unit (553) in the form of symbols (521) that can have, for example X, Y, and reference picture components. Motion compensation also can include interpolation of sample values as fetched from the reference picture memory (557) when sub-sample exact motion vectors are in use, motion vector prediction mechanisms, and so forth.

The output samples of the aggregator (555) can be subject to various loop filtering techniques in the loop filter unit (556). Video compression technologies can include in-loop filter technologies that are controlled by parameters included in the coded video sequence (also referred to as coded video bitstream) and made available to the loop filter unit (556) as symbols (521) from the parser (520), but can also be responsive to meta-information obtained during the decoding of previous (in decoding order) parts of the coded picture or coded video sequence, as well as responsive to previously reconstructed and loop-filtered sample values.

The output of the loop filter unit (556) can be a sample stream that can be output to a render device as well as stored in the reference picture memory (557) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (520)), the current picture buffer (558) can become a part of the reference picture memory (557), and a fresh current picture buffer can be reallocated before commencing the reconstruction of the following coded picture.

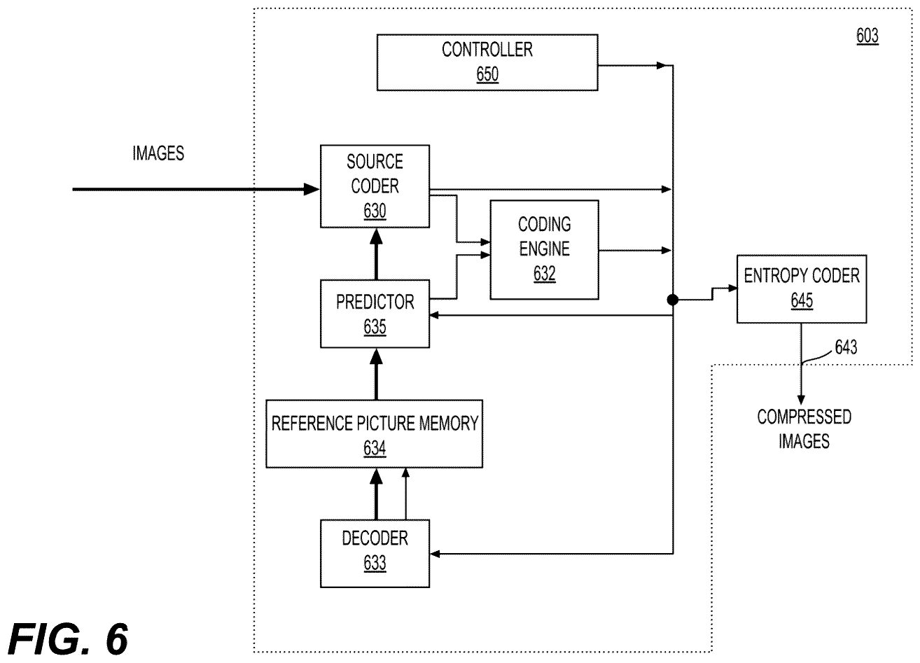

FIG. 6 shows a block diagram of a video encoder (603) according to an embodiment of the present disclosure. The video encoder (603) can be used in the V-PCC encoder (300) that compresses point clouds. In an example, the video compression module (322) and (323), and the video compression module (332) are configured similarly to the encoder (603).

The video encoder (603) may receive images, such as padded geometry images, padded texture images and the like, and generate compressed images.

According to an embodiment, the video encoder (603) may code and compress the pictures of the source video sequence (images) into a coded video sequence (compressed images) in real time or under any other time constraints as required by the application. Enforcing appropriate coding speed is one function of a controller (650). In some embodiments, the controller (650) controls other functional units as described below and is functionally coupled to the other functional units. The coupling is not depicted for clarity. Parameters set by the controller (650) can include rate control related parameters (picture skip, quantizer, lambda value of rate-distortion optimization techniques, . . . ), picture size, group of pictures (GOP) layout, maximum motion vector search range, and so forth. The controller (650) can be configured to have other suitable functions that pertain to the video encoder (603) optimized for a certain system design.

In some embodiments, the video encoder (603) is configured to operate in a coding loop. As an oversimplified description, in an example, the coding loop can include a source coder (630) (e.g., responsible for creating symbols, such as a symbol stream, based on an input picture to be coded, and a reference picture(s)), and a (local) decoder (633) embedded in the video encoder (603). The decoder (633) reconstructs the symbols to create the sample data in a similar manner as a (remote) decoder also would create (as any compression between symbols and coded video bitstream is lossless in the video compression technologies considered in the disclosed subject matter). The reconstructed sample stream (sample data) is input to the reference picture memory (634). As the decoding of a symbol stream leads to bit-exact results independent of decoder location (local or remote), the content in the reference picture memory (634) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (633) can be the same as of a “remote” decoder, such as the video decoder (510), which has already been described in detail above in conjunction with FIG. 5. Briefly referring also to FIG. 5, however, as symbols are available and encoding/decoding of symbols to a coded video sequence by an entropy coder (645) and the parser (520) can be lossless, the entropy decoding parts of the video decoder (510), including and parser (520) may not be fully implemented in the local decoder (633).

During operation, in some examples, the source coder (630) may perform motion compensated predictive coding, which codes an input picture predictively with reference to one or more previously-coded picture from the video sequence that were designated as “reference pictures”. In this manner, the coding engine (632) codes differences between pixel blocks of an input picture and pixel blocks of reference picture(s) that may be selected as prediction reference(s) to the input picture.

The local video decoder (633) may decode coded video data of pictures that may be designated as reference pictures, based on symbols created by the source coder (630). Operations of the coding engine (632) may advantageously be lossy processes. When the coded video data may be decoded at a video decoder (not shown in FIG. 6), the reconstructed video sequence typically may be a replica of the source video sequence with some errors. The local video decoder (633) replicates decoding processes that may be performed by the video decoder on reference pictures and may cause reconstructed reference pictures to be stored in the reference picture cache (634). In this manner, the video encoder (603) may store copies of reconstructed reference pictures locally that have common content as the reconstructed reference pictures that will be obtained by a far-end video decoder (absent transmission errors).

The predictor (635) may perform prediction searches for the coding engine (632). That is, for a new picture to be coded, the predictor (635) may search the reference picture memory (634) for sample data (as candidate reference pixel blocks) or certain metadata such as reference picture motion vectors, block shapes, and so on, that may serve as an appropriate prediction reference for the new pictures. The predictor (635) may operate on a sample block-by-pixel block basis to find appropriate prediction references. In some cases, as determined by search results obtained by the predictor (635), an input picture may have prediction references drawn from multiple reference pictures stored in the reference picture memory (634).

The controller (650) may manage coding operations of the source coder (630), including, for example, setting of parameters and subgroup parameters used for encoding the video data.

Output of all aforementioned functional units may be subjected to entropy coding in the entropy coder (645). The entropy coder (645) translates the symbols as generated by the various functional units into a coded video sequence, by lossless compressing the symbols according to technologies such as Huffman coding, variable length coding, arithmetic coding, and so forth.

The controller (650) may manage operation of the video encoder (603). During coding, the controller (650) may assign to each coded picture a certain coded picture type, which may affect the coding techniques that may be applied to the respective picture. For example, pictures often may be assigned as one of the following picture types:

The video encoder (603) may perform coding operations according to a predetermined video coding technology or standard, such as ITU-T Rec. H.265. In its operation, the video encoder (603) may perform various compression operations, including predictive coding operations that exploit temporal and spatial redundancies in the input video sequence. The coded video data, therefore, may conform to a syntax specified by the video coding technology or standard being used.

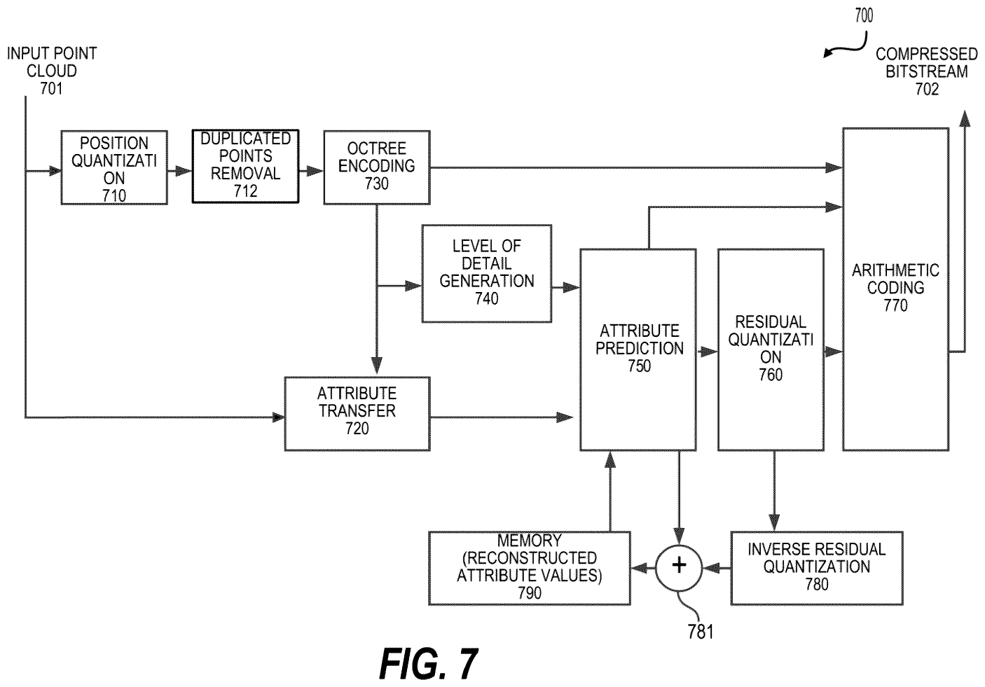

FIG. 7 shows a block diagram of a G-PCC encoder (700) in some examples. The G-PCC encoder (700) can be configured to receive point cloud data and compress the point cloud data to generate a bit stream carrying compressed point cloud data. In an embodiment, the G-PCC encoder (700) can include a position quantization module (710), a duplicated points removal module (712), an octree encoding module (730), an attribute transfer module (720), a level of detail (LOD) generation module (740), an attribute prediction module (750), a residual quantization module (760), an arithmetic coding module (770), an inverse residual quantization module (780), an addition module (781), and a memory (790) to store reconstructed attribute values.

As shown, an input point cloud (701) can be received at the G-PCC encoder (700). Positions (e.g., 3D coordinates) of the point cloud (701) are provided to the quantization module (710). The quantization module (710) is configured to quantize the coordinates to generate quantized positions. The duplicated points removal module (712) is configured to receive the quantized positions and perform a filter process to identify and remove duplicated points. The octree encoding module (730) is configured to receive filtered positions from the duplicated points removal module (712), and perform an octree-based encoding process to generate a sequence of occupancy codes that describe a 3D grid of voxels. The occupancy codes are provided to the arithmetic coding module (770).

The attribute transfer module (720) is configured to receive attributes of the input point cloud, and perform an attribute transfer process to determine an attribute value for each voxel when multiple attribute values are associated with the respective voxel. The attribute transfer process can be performed on the re-ordered points output from the octree encoding module (730). The attributes after the transfer operations are provided to the attribute prediction module (750). The LOD generation module (740) is configured to operate on the re-ordered points output from the octree encoding module (730), and re-organize the points into different LODs. LOD information is supplied to the attribute prediction module (750).

The attribute prediction module (750) processes the points according to an LOD-based order indicated by the LOD information from the LOD generation module (740). The attribute prediction module (750) generates an attribute prediction for a current point based on reconstructed attributes of a set of neighboring points of the current point stored in the memory (790). Prediction residuals can subsequently be obtained based on original attribute values received from the attribute transfer module (720) and locally generated attribute predictions. When candidate indices are used in the respective attribute prediction process, an index corresponding to a selected prediction candidate may be provided to the arithmetic coding module (770).

The residual quantization module (760) is configured to receive the prediction residuals from the attribute prediction module (750), and perform quantization to generate quantized residuals. The quantized residuals are provided to the arithmetic coding module (770).

The inverse residual quantization module (780) is configured to receive the quantized residuals from the residual quantization module (760), and generate reconstructed prediction residuals by performing an inverse of the quantization operations performed at the residual quantization module (760). The addition module (781) is configured to receive the reconstructed prediction residuals from the inverse residual quantization module (780), and the respective attribute predictions from the attribute prediction module (750). By combining the reconstructed prediction residuals and the attribute predictions, the reconstructed attribute values are generated and stored to the memory (790).

The arithmetic coding module (770) is configured to receive the occupancy codes, the candidate indices (if used), the quantized residuals (if generated), and other information, and perform entropy encoding to further compress the received values or information. As a result, a compressed bitstream (702) carrying the compressed information can be generated. The bitstream (702) may be transmitted, or otherwise provided, to a decoder that decodes the compressed bitstream, or may be stored in a storage device.

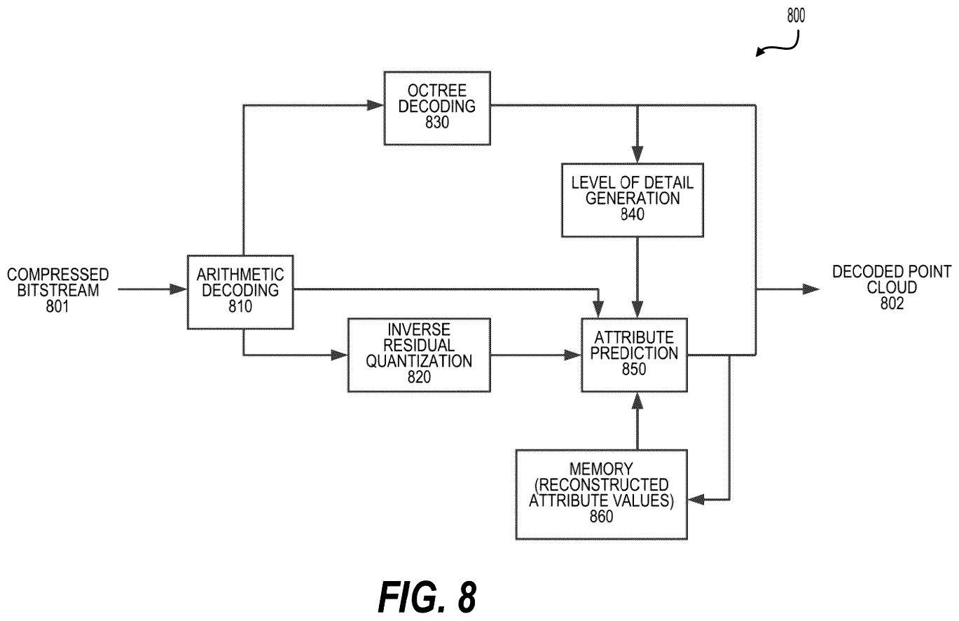

FIG. 8 shows a block diagram of a G-PCC decoder (800) in accordance with an embodiment. The G-PCC decoder (800) can be configured to receive a compressed bitstream and perform point cloud data decompression to decompress the bitstream to generate decoded point cloud data. In an embodiment, the G-PCC decoder (800) can include an arithmetic decoding module (810), an inverse residual quantization module (820), an octree decoding module (830), an LOD generation module (840), an attribute prediction module (850), and a memory (860) to store reconstructed attribute values.

As shown, a compressed bitstream (801) can be received at the arithmetic decoding module (810). The arithmetic decoding module (810) is configured to decode the compressed bitstream (801) to obtain quantized residuals (if generated) and occupancy codes of a point cloud. The octree decoding module (830) is configured to determine reconstructed positions of points in the point cloud according to the occupancy codes. The LOD generation module (840) is configured to re-organize the points into different LODs based on the reconstructed positions, and determine an LOD-based order. The inverse residual quantization module (820) is configured to generate reconstructed residuals based on the quantized residuals received from the arithmetic decoding module (810).

The attribute prediction module (850) is configured to perform an attribute prediction process to determine attribute predictions for the points according to the LOD-based order. For example, an attribute prediction of a current point can be determined based on reconstructed attribute values of neighboring points of the current point stored in the memory (860). In some examples, the attribute prediction can be combined with a respective reconstructed residual to generate a reconstructed attribute for the current point.

A sequence of reconstructed attributes generated from the attribute prediction module (850) together with the reconstructed positions generated from the octree decoding module (830) corresponds to a decoded point cloud (802) that is output from the G-PCC decoder (800) in one example. In addition, the reconstructed attributes are also stored into the memory (860) and can be subsequently used for deriving attribute predictions for subsequent points.

In various embodiments, the encoder (300), the decoder (400), the encoder (700), and/or the decoder (800) can be implemented with hardware, software, or combination thereof. For example, the encoder (300), the decoder (400), the encoder (700), and/or the decoder (800) can be implemented with processing circuitry such as one or more integrated circuits (ICs) that operate with or without software, such as an application specific integrated circuit (ASIC), field programmable gate array (FPGA), and the like. In another example, the encoder (300), the decoder (400), the encoder (700), and/or the decoder (800) can be implemented as software or firmware including instructions stored in a non-volatile (or non-transitory) computer-readable storage medium. The instructions, when executed by processing circuitry, such as one or more processors, causing the processing circuitry to perform functions of the encoder (300), the decoder (400), the encoder (700), and/or the decoder (800).

It is noted that the attribute prediction modules (750) and (850) configured to implement the attribute prediction techniques disclosed herein can be included in other decoders or encoders that may have similar or different structures from what is shown in FIG. 7 and FIG. 8. In addition, the encoder (700) and decoder (800) can be included in a same device, or separate devices in various examples.

According to some aspects of the disclosure, mesh compression can use coding tools different from PCC coding tools or can use PCC coding tools, such as above PCC (e.g., G-PCC, V-PCC) encoders, above PCC (e.g., G-PCC, V-PCC) decoders, and the like.

A mesh (also referred to as a mesh model, a mesh frame) of an object can include polygons that describe the surface of the object. Each polygon can be defined by vertices of the polygon in 3D space and edges that connect the vertices into the polygon. The information of how the vertices are connected (e.g., information of the edges) is referred to as connectivity information. In some examples, a mesh of an object is formed by connected triangles that describe the surface of the object. Two triangles sharing an edge are referred to as two connected triangles. In some other examples, a mesh of an object is formed by connected quadrilaterals. Two quadrilaterals sharing an edge can be referred to as two connected quadrilaterals. It is noted that meshes can be formed by other suitable polygons.

Some aspects of the disclosure provide techniques to generate volumetric segmentation masks for instance segmentation of a point cloud and to generate associated metadata relating to the point cloud for use with point cloud optimization.

According to an aspect of the disclosure, uncompressed or raw point cloud data of dynamic human subjects and objects can result in large file sizes. Point cloud optimization can reduce file size. Point cloud optimization can include voxelization that refers to the process to convert a point cloud into a voxel grid and estimate the geometries and attributes associated with voxels in the voxel grid. In some related examples, point cloud optimization may rely on manual processing, and are not suitable for real time capture to transmission pipelines. In some related examples, voxelization does not take into account visual features that have higher visual sensitivity and require higher detail, such as human facial regions and other areas of high visual saliency.

Some aspects of the disclosure provide techniques of instance segmentation that do not rely on manual processing, and the techniques of instance segmentation can be integrated into a pipeline for point cloud processing in an electronic device. The techniques of instance segmentation can generate one or more segmentation masks for a point cloud, and the one or more segmentation masks can assist further point cloud processing. For example, the point cloud can be divided into segmentation instances according to the one or more segmentation masks, and different processing parameters can be applied to different segmentation instances. For example, the segmentation masks can be used to retain details of some segmentation instances, such as facial features, and can be used to reduce redundancy of some segmentation instances, such as a torso portion.

According to an aspect of the disclosure, a point cloud, such as a point cloud of uncompressed or raw point cloud data having dense points, can be rendered according to one or more virtual cameras to generate virtual camera views (e.g., images in 2D plane). The virtual camera views can be regarded as the projections of the point cloud data in 3D space onto 2D planes. In some examples, the virtual camera views are used to perform instance segmentation. In some examples, the virtual camera views are fed into a fully-convolutional model or other suitable systems for real-time instance segmentation. In some examples, the results of the instance segmentation include 2D pixel-wise masks associated with the segmentated elements (e.g., instances). In some examples, the results are then used as additional inputs for enhanced downstream attribute and geometry coding, and point cloud optimization.

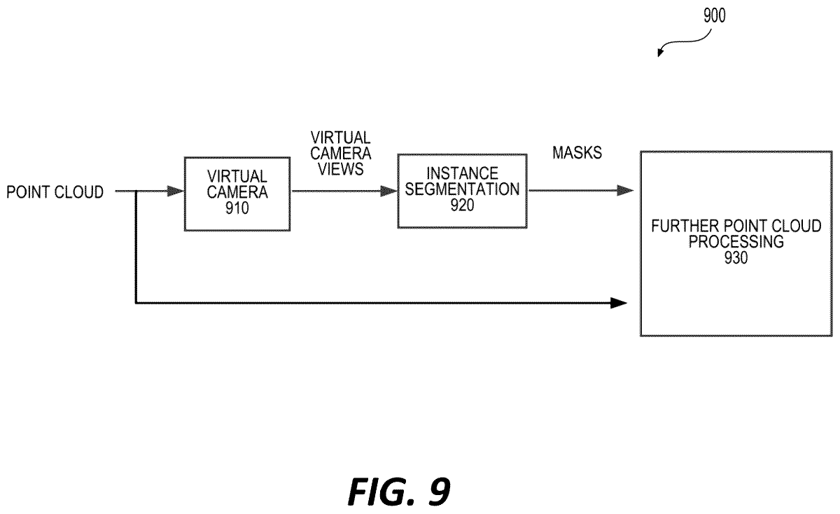

FIG. 9 shows a diagram of a computer system (900) according to an embodiment of the disclosure. The computer system (900) includes a virtual camera module (910), an instance segmentation module (920) and a further point cloud processing module (930). The various modules in the computer system (900) can be implemented by various techniques. In some examples, the various modules are implemented by hardware circuitry to perform the various functions. In some examples, the various modules are implemented in software instructions, and software instructions can be executed by one or more processors to perform various functions.

In some examples, the computer system (900) is configured to process a point cloud, such as a point cloud of uncompressed or raw point cloud data having dense points. The virtual camera module (910) can render virtual camera views for the point cloud according to virtual camera parameters, such as virtual camera positions, virtual camera angles, virtual camera focus, virtual camera field of view, and the like. The virtual camera views can be regarded as the projections of the point cloud data in 3D space onto 2D planes. In some examples, the virtual camera parameters are set based on knowledge of previously trained data such as 3D human portrait datasets.

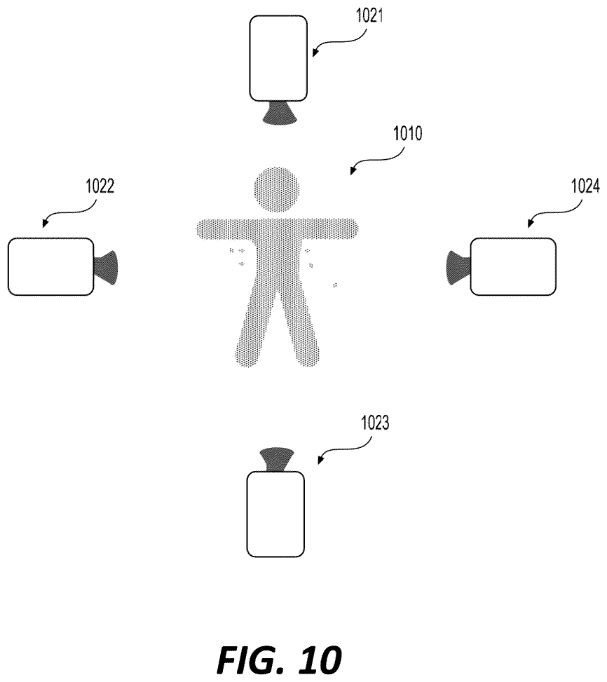

FIG. 10 shows a diagram for generating multiple virtual camera views in some examples. In the FIG. 10 example, four virtual cameras (1021)-(1024) are configured to project a point cloud (1010) to four 2D planes. The four virtual cameras (1021)-(1024) can have respective virtual camera parameters, such as respective virtual camera positions, virtual camera angles, virtual camera focus, virtual camera field of view, and the like. In some examples, the virtual camera parameters are set based on knowledge of previously trained data such as 3D human portrait datasets.

Referring back to FIG. 9, in some examples, the instance segmentation module (920) can generate one or more pixel wise masks corresponding to instances in the point cloud according to the virtual camera views. In an example, the instance segmentation module (920) includes artificial neural networks, such as fully-convolutional neural network models, and the like that are trained to generate pixel wise masks from the virtual camera views at real-time.

A pixel wise mask is a semantic and segmented pixel grouping that assigns per-pixel correlation to objects in a 2D frame (e.g., 2D image, virtual camera view and the like). In an example, a point cloud corresponds to a scene having four penguins. The instance segmentation module (920) can generate 4 pixel wise masks for a virtual camera view, and each penguin is assigned a pixel wise mask of the 4 pixel wise masks, and the pixel wise mask of a penguin can describe every pixel of the penguin. The pixel wise masks can be any suitable masks, such as a binary mask, a RGB mask, and the like.

In some examples, pixel wise masks can include metadata correlating the virtual camera views to the pixel wise masks. For example, a pixel wise mask can include metadata indicative of the virtual camera pose, field-of-view of the virtual camera, size of virtual sensor in the virtual camera, resolution of the virtual camera, aspect ratio of the virtual camera, and the like.

In some examples, a point cloud corresponds to a scene having a person. The virtual camera module (910) generates one or more virtual camera views, and the virtual camera views can be input to the instance segmentation module (920). The instance segmentation module (920) includes fully-convolutional neural network models that are trained to generate pixel wise masks of segments of the person, recognize features of the segments, and generate metadata for the pixel-wise masks. For example, the instance segmentation module (920) can generate a pixel wise mask of the person, and the pixel wise mask can include sub masks corresponding to head, arm, legs, body, eyes, mouth, and the like. The sub masks can be assigned with metadata that can be indicative of the segment name, and the like.

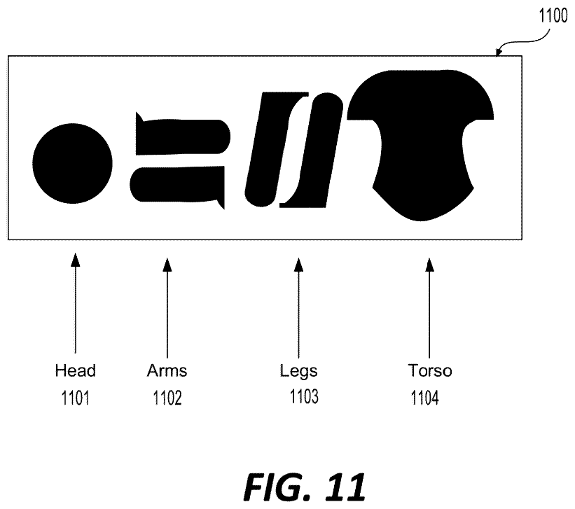

FIG. 11 shows an example of a pixel wise mask (1100) in some examples. For example, the pixel wise mask (1100) is generated according to the virtual camera views of the point cloud (1010). The pixel wise mask (1100) can include sub masks (1101)-(1104). In some examples, a pixel wise mask can be configured according to a UV atlas (or a UV map). In some examples, a UV mapping technique generates a UV atlas (also referred to as UV map) in 2D. The UV atlas includes assignments of 3D points to 2D points in a 2D domain. The UV atlas is a mapping between coordinates of the 3D to coordinates of 2D domain. In an example, a point in the UV atlas at a 2D coordinates (u,v) has a value that is formed by coordinates (x, y, z) of a point in the 3D domain. In some examples, a pixel in the pixel wise mask (1100) has a corresponding pixel in a UV atlas. The corresponding pixel in the UV atlas include 3D coordinates of a corresponding point in the point cloud (1010). In an example, a pixel in the pixel wise mask (1100) can have a binary value or a RGB vector value. In some examples, the sub masks (1101)-(1104) may have metadata indicative of different segments. For example, the sub mask (1101) has metadata indicative of head of the person; the sub mask (1102) has metadata indicative of arms of the person; the sub mask (1103) has metadata indicative of legs of the person; and the sub mask (1104) has metadata indicative of torso of the person.

Referring back to FIG. 9, in some examples, the further point cloud processing module (930) can process the point cloud based on the pixel wise masks. The further point cloud processing module (930) can perform any suitable processing. In an example, the further point cloud processing module (930) can perform encoding, such as attribute and geometry coding, of the point cloud based on the pixel wise masks. In another example, the further point cloud processing module (930) can perform point cloud optimization, such as voxelization, based on the pixel wise masks.

In some examples, the pixel wise masks and the metadata associated with the pixel wise masks are used to generate a voxel grid, such as a Eulerian voxel grid, a non-Eulerian voxel grid, a cubic voxel grid, a non-cubic voxel grid, and the like from the point cloud. The voxel grid can be improved according to the pixel wise masks. In an example, according to the pixel wise masks, a Eulerian voxel grid can be generated to retain details of facial features and frequent objects of interest as well as known human visual saliency features. For example, the pixel wise masks include a sub mask for human face, and the Eulerian voxel grid can be generated to include finer grids for the human face in order to retain the highest level of details and quality of the human face, so that the encoded data of the point cloud provides high resolution for the human face. In another example, according to the pixel wise masks, the Eulerian voxel grid can be generated to include larger (e.g., wider) grids for torso portion of the human, and redundant voxels/points at the torso portion can be removed to improve coding efficiency, thus the encoded data of the point cloud may provide relatively low resolution for the torso portion.

It is noted that the voxel grid can be cubic based voxel grid or can be non-cubic based voxel grid. In an example, a Eulerian voxel grid is a cubic based voxel grid that is formed by cubic voxels with different sizes. In another example, a Eulerian voxel grid is a non-cubic based voxel grid, such as a sphere based voxel grid that is formed by sphere voxels with different sizes. It is also noted that in some examples, the pixel-wise masks are used as inputs to help place a collection of voxels stored in a non-Eularian arrangement.

In some examples, the objects local coordinate system origin and object pose can be set based on pre-trained parameters. In an example, metadata describing the objects kinematics, joints, links, base link, center of mass, and the like can be determined in the pixel wise masks based on pre-trained parameters. The pixel wise masks and the associated metadata can be used with downstream renderers, 3D Engines, and simulation environments. In an example, some pixel wise masks are described as joints and bones based on the metadata associated with the pixel wise masks. The pixel wise masks and the metadata can be used, for example, to generate new poses for the human.

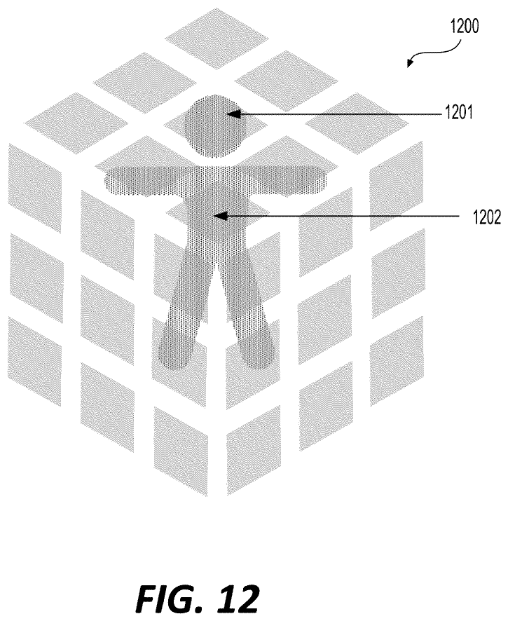

FIG. 12 shows a diagram of voxelization in some examples. The voxelization can transform a point cloud into a voxel grid. In the FIG. 12 example, the voxelization can convert a point cloud, such as the point cloud (1010), into a voxel grid, according to the pixel wise mask (1100). In an example, a first point (1201) in the point cloud is identified as a point in an eye segment by pixel wise mask. The first point (1201) is converted to a voxel of a finer grid (e.g., smallest grid in an example) to retain details of the eye segment. In another example, a second point (1202) in the point cloud is identified as a point in a torso segment by pixel wise mask. The second point (1202) is converted to a voxel of a larger grid (e.g., a largest grid in an example). In some examples, some neighboring points of the second point (1202) are converted to the same voxel as the second point (1202), and are considered to as redundant voxel/points. The redundant voxel/points can be removed to reduce file size of the encoded point cloud.

In some examples, pixel wise masks and their associated metadata are used to generate enhanced watertight geometry from the point cloud. In some examples, a mesh corresponding to the point cloud is generated based on the pixel wise masks and associated metadata. The mesh can be formed by polygons, such as triangles, rectangles and the like. Based on the pixel wise masks and their associated metadata, different sizes of polygons can be used, for example, at different portions of a human. For example, relatively smaller sizes of polygons are used at the face portion of the mesh representing the human to retain details of the facial features, and relatively larger polygons are used at the torso portion of the mesh representing the human to improve coding efficiency. Further, according to the metadata, features of different portions can be determined, and conversion errors can be avoided. For example, in response to a pixel wise mask with metadata identifying a hand, a portion of the point cloud corresponding to the pixel wise mask can be converted to a mesh representing the hand with general hand features, such as 5 fingers.

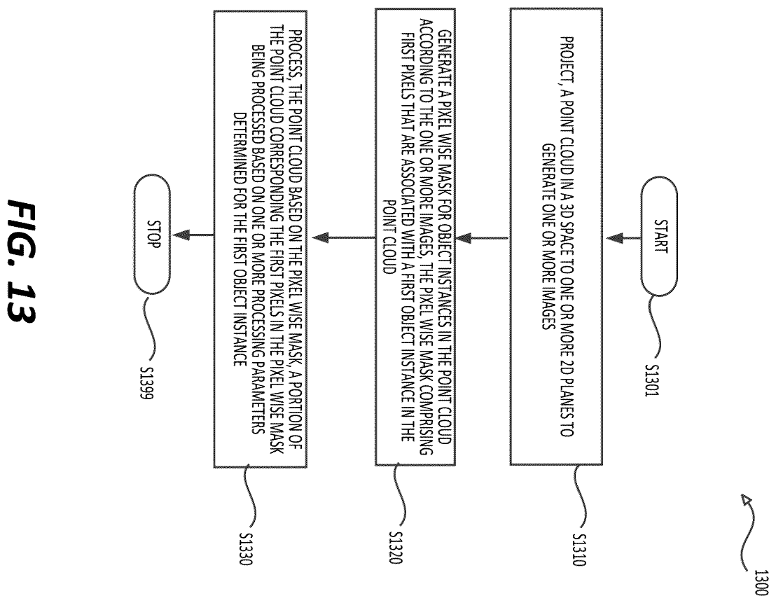

FIG. 13 shows a flow chart outlining a process (1300) according to an embodiment of the disclosure. The process (1300) can be used during point cloud processing. In various embodiments, the process (1300) is executed by processing circuitry. In some embodiments, the process (1300) is implemented in software instructions, thus when the processing circuitry executes the software instructions, the processing circuitry performs the process (1300). The process starts at (S1301) and proceeds to (S1310).

At (S1310), a point cloud in a three dimensional (3D) space is projected to one or more two dimensional (2D) planes to generate one or more images in 2D.

At (S1320), a pixel wise mask for object instances in the point cloud is generated according to the one or more images. The pixel wise mask includes first pixels that are associated with a first object instance in the point cloud.

At (S1330), the point cloud is processed based on the pixel wise mask, a portion of the point cloud corresponding the first pixels in the pixel wise mask is processed based on one or more processing parameters that are determined for the first object instance.

In some examples, the one or more images are input into a convolutional neural network model that is trained to generate pixel wise mask for object instances. In an example, a pixel wise mask including mask information and associated metadata is created from one or more virtual camera views using a trained convolutional neural network.

In some examples, the one or more images are input into a non neural network based logic model that is configured to generate pixel wise masks for object instances. In an example, a pixel wise mask including the mask information and associated metadata is created from one or more virtual camera views using non artificial intelligence based logic.

In some examples, the point cloud includes points representing a person. The pixel wise mask can include a plurality of sub masks respectively associated with facial elements and body elements of person. In an example, separate masks (e.g., sub masks) are generated for facial elements (e.g., eyes, nose, mouth, and the like), arms, legs, torso, and the like separately.

In some examples, respective parameters of one or more virtual cameras associated with the one or more 2D planes for a projection of the point cloud are determined according to pretrained data. In an example, the virtual camera pose and orientation are set based on knowledge of previously trained data, such as 3D human portrait datasets.

In some examples, different parameters for voxelating different object instances are determined, and voxelating is performed accordingly. For example, first parameters for voxelating the first object instance are determined and the portion of the point cloud corresponding the first pixels in the pixel wise mask is voxelated according to the first parameters. For example, the pixel wise mask is used to compute voxel unit size, and bounding boxes of one or more voxel grids. In an example, multiple voxel grids, or a container grid that contains multiple child grids, temporally or spatially displaced can be inputs to a voxelization optimizer, the voxelization optimizer can then output one or more rectified, optimized, combined, or otherwise improved voxel grids.

In some examples, to process the point cloud, a scene graph associated with the point cloud is generated based on the pixel wise mask, the scene graph includes at least a first scene graph element for the first object instance. In an example, the pixel wise mask is input to a scene graph processor for the streaming of scene graph elements. The scene graph elements can be provided to decoders, intermediary software, and renderers to assist processing.

In some examples, the pixel wise mask is used to generate a grid of cubic voxels. In some examples, the pixel wise mask is used to generate a grid of non-cubic voxels.

In some examples, the pixel wise mask is used to generate voxels stored in a Eularian arrangement. In some examples, the pixel wise mask is used to generate voxels stored in a non-Eularian arrangement.

In some examples, the point cloud with the pixel wise mask is processed by a video based point cloud compression (V-PCC) system. For example, the pixel wise mask is used as input to a video based point cloud compression (such as MPEG V-PCC) system.

In some examples, the point cloud is divided into a plurality of segments according to the pixel wise mask having a plurality of sub masks corresponding to the plurality of segments. The plurality of segments are packed respectively into geometry maps and the geometry maps are encoded into respective sub streams. In an example, the pixel wise mask is used to subdivide the point cloud into multiple segments, and each segment can be packed into a geometry map, and the geometry maps are encoded by MPEG V-PCC into different sub streams.

In some examples, 2D patches are generated respectively for the plurality of segments based on the pixel wise mask, a 2D patch for a segment includes geometry information and semantic information of the 2D patch. In an example, the pixel wise mask is used to facilitate the 2D patch generation process in MPEG V-PCC, such that the 2D patches not only carry the geometry/texture information but also carry semantic information.

In some examples, coding parameters, such as a quantization parameter for encoding the portion of the point cloud can be determined based on the pixel wise mask. In an example, the pixel wise mask can be used to decide the coding parameters for each segment. For example, the segments of the human face use a smaller quantization parameter while being coded by a video codec.

In some examples, the point cloud with the pixel wise mask is processed by a geometry based point cloud compression (G-PCC) system. In an example, the pixel wise mask is used as input to a geometry based point cloud compression (such as MPEG G-PCC) system.

In some examples, the point cloud is divided into multiple slices based on the pixel wise mask. Further, encoder parameters respectively for the multiple slices are determined based on respective characteristics of the multiple slices, and the multiple slices are encoded respectively into respective sub streams based on the encoder parameters. In an example, the pixel wise mask is used to subdivide the point cloud into multiple slices, and each slice can be coded by MPEG G-PCC into a sub stream. Each slice can be assigned with different sets of encoder parameters to fit the characteristics of the slice.

In some examples, geometry quantization parameters for octree partitioning are determined based on the pixel wise mask, and the octree partitioning is performed based on the geometry quantization parameters. In an example, the pixel wise mask is used to decide different internal geometry quantization parameters that are used while octree partitioning in MPEG G-PCC. For example, when an octree node that includes most of the regions of a human face, a smaller geometry quantization parameter is applied in the octree node.

Then, the process proceeds to (S1399) and terminates.

The process (1300) can be suitably adapted. Step(s) in the process (1300) can be modified and/or omitted. Additional step(s) can be added. Any suitable order of implementation can be used.

The techniques disclosed in the present disclosure may be used separately or combined in any order. Further, each of the techniques (e.g., methods, embodiments), encoder, and decoder may be implemented by processing circuitry (e.g., one or more processors or one or more integrated circuits). In some examples, the one or more processors execute a program that is stored in a non-transitory computer-readable medium.

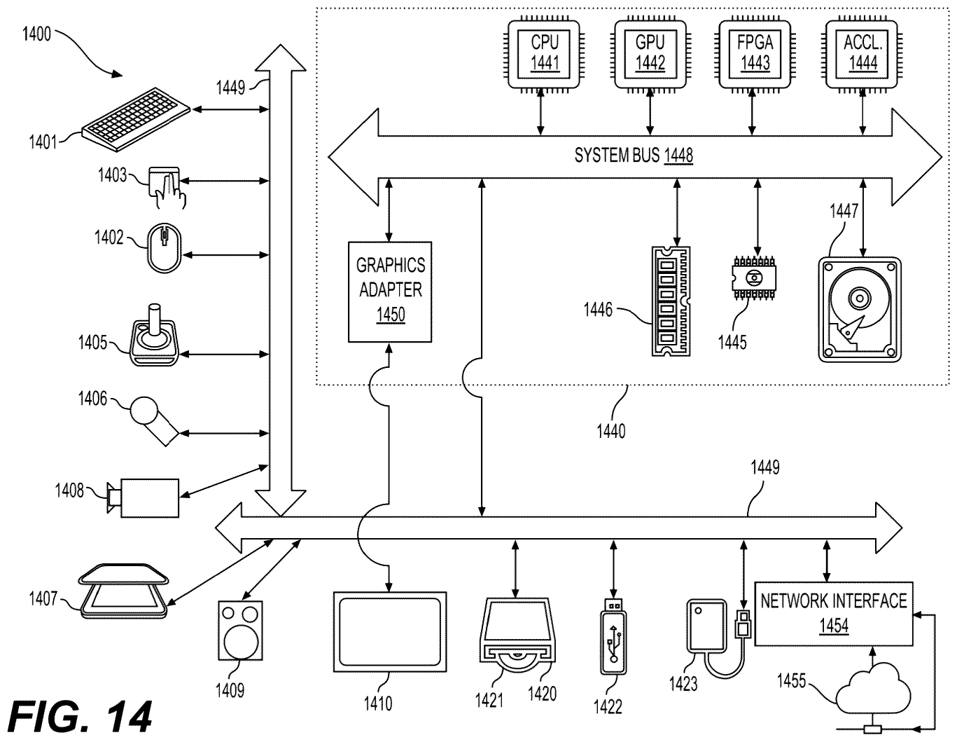

The techniques described above, can be implemented as computer software using computer-readable instructions and physically stored in one or more computer-readable media. For example, FIG. 14 shows a computer system (1400) suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 14 for computer system (1400) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (1400).

Computer system (1400) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1401), mouse (1402), trackpad (1403), touch screen (1410), data-glove (not shown), joystick (1405), microphone (1406), scanner (1407), camera (1408).

Computer system (1400) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1410), data-glove (not shown), or joystick (1405), but there can also be tactile feedback devices that do not serve as input devices), audio output devices (such as: speakers (1409), headphones (not depicted)), visual output devices (such as screens (1410) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system (1400) can also include human accessible storage devices and their associated media such as optical media including CD/DVD ROM/RW (1420) with CD/DVD or the like media (1421), thumb-drive (1422), removable hard drive or solid state drive (1423), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1400) can also include an interface (1454) to one or more communication networks (1455). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1449) (such as, for example USB ports of the computer system (1400)); others are commonly integrated into the core of the computer system (1400) by attachment to a system bus as described below (for example Ethernet interface into a PC computer system or cellular network interface into a smartphone computer system). Using any of these networks, computer system (1400) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1440) of the computer system (1400).

The core (1440) can include one or more Central Processing Units (CPU) (1441), Graphics Processing Units (GPU) (1442), specialized programmable processing units in the form of Field Programmable Gate Areas (FPGA) (1443), hardware accelerators for certain tasks (1444), graphics adapters (1450), and so forth. These devices, along with Read-only memory (ROM) (1445), Random-access memory (1446), internal mass storage such as internal non-user accessible hard drives, SSDs, and the like (1447), may be connected through a system bus (1448). In some computer systems, the system bus (1448) can be accessible in the form of one or more physical plugs to enable extensions by additional CPUs, GPU, and the like. The peripheral devices can be attached either directly to the core's system bus (1448), or through a peripheral bus (1449). In an example, the screen (1410) can be connected to the graphics adapter (1450). Architectures for a peripheral bus include PCI, USB, and the like.

CPUs (1441), GPUs (1442), FPGAs (1443), and accelerators (1444) can execute certain instructions that, in combination, can make up the aforementioned computer code. That computer code can be stored in ROM (1445) or RAM (1446). Transitional data can be also be stored in RAM (1446), whereas permanent data can be stored for example, in the internal mass storage (1447). Fast storage and retrieve to any of the memory devices can be enabled through the use of cache memory, that can be closely associated with one or more CPU (1441), GPU (1442), mass storage (1447), ROM (1445), RAM (1446), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1400), and specifically the core (1440) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1440) that are of non-transitory nature, such as core-internal mass storage (1447) or ROM (1445). The software implementing various embodiments of the present disclosure can be stored in such devices and executed by core (1440). A computer-readable medium can include one or more memory devices or chips, according to particular needs. The software can cause the core (1440) and specifically the processors therein (including CPU, GPU, FPGA, and the like) to execute particular processes or particular parts of particular processes described herein, including defining data structures stored in RAM (1446) and modifying such data structures according to the processes defined by the software. In addition or as an alternative, the computer system can provide functionality as a result of logic hardwired or otherwise embodied in a circuit (for example: accelerator (1444)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof

What is claimed is:

1. A method for point cloud processing, comprising:
obtaining point cloud data corresponding to a point cloud in a three dimensional (3D) space;
projecting, the point cloud in the 3D space to one or more two dimensional (2D) planes to generate one or more images;
generating a pixel wise mask for object instances in the point cloud according to the one or more images, the pixel wise mask comprising first pixels that are associated with a first object instance in the point cloud; and
processing, the point cloud based on the pixel wise mask, a portion of the point cloud corresponding the first pixels in the pixel wise mask being processed based on one or more processing parameters determined for the first object instance.

2. The method of claim 1, wherein the generating the pixel wise mask comprises at least one of:
inputting the one or more images into a convolutional neural network model that is trained to generate pixel wise mask for object instances; and/or
inputting the one or more images into a non neural network based logic model that is configured to generate pixel wise masks for object instances.

3. The method of claim 1, wherein the point cloud comprises points representing a person, and the generating the pixel wise mask further comprises:
generating the pixel wise mask that includes a plurality of sub masks respectively associated with facial elements and body elements of the person.

4. The method of claim 1, wherein the projecting the point cloud further comprises:
determining respective parameters of one or more virtual cameras associated with the one or more 2D planes for a projection of the point cloud according to pretrained data.

5. The method of claim 1, wherein the processing the point cloud further comprises:
determining first parameters for voxelating the first object instance; and
voxelating the portion of the point cloud corresponding the first pixels in the pixel wise mask according to the first parameters.

6. The method of claim 1, wherein the processing the point cloud further comprises:
generating a scene graph associated with the point cloud based on the pixel wise mask, the scene graph including at least a first scene element identifying the first object instance.

7. The method of claim 1, wherein the processing the point cloud further comprises:
processing the point cloud with the pixel wise mask by a video based point cloud compression (V-PCC) system.

8. The method of claim 7, further comprising:
dividing the point cloud into a plurality of segments according to the pixel wise mask having a plurality of sub masks corresponding to the plurality of segments;
packing the plurality of segments respectively into geometry maps; and
encoding the geometry maps into respective sub streams.

9. The method of claim 8, further comprising:
generating 2D patches respectively for the plurality of segments based on the pixel wise mask, a 2D patch for a segment including geometry information and semantic information of the 2D patch.

10. The method of claim 7, further comprising:
determining a quantization parameter for encoding the portion of the point cloud based on the pixel wise mask.

11. The method of claim 1, wherein the processing the point cloud further comprises:
processing the point cloud with the pixel wise mask by a geometry based point cloud compression (G-PCC) system.

12. The method of claim 11, further comprising:
dividing the point cloud into multiple slices based on the pixel wise mask;
determining encoder parameters respectively for the multiple slices based on respective characteristics; and
encoding respectively the multiple slices into respective sub streams based on the encoder parameters.

13. The method of claim 11, further comprising:
determining geometry quantization parameters for octree partitioning based on the pixel wise mask; and
performing the octree partitioning based on the geometry quantization parameters.

14. An apparatus for point cloud processing, comprising processing circuitry configured to:
obtain point cloud data corresponding to a point cloud in a three dimensional (3D) space;
project, the point cloud in the 3D space to one or more two dimensional (2D) planes to generate one or more images;
generate a pixel wise mask for object instances in the point cloud according to the one or more images, the pixel wise mask comprising first pixels that are associated with a first object instance in the point cloud; and
process the point cloud based on the pixel wise mask, a portion of the point cloud corresponding the first pixels in the pixel wise mask being processed based on one or more processing parameters determined for the first object instance.

15. The apparatus of claim 14, wherein the processing circuitry is configured to generate pixel wise mask for object instances based on at least one of a convolutional neural network model and/or a non neural network based logic.

16. The apparatus of claim 14, wherein the point cloud comprises points representing a person, and the processing circuitry is configured to:
generate the pixel wise mask that includes a plurality of sub masks respectively associated with facial elements and body elements of the person.

17. The apparatus of claim 14, wherein the processing circuitry is configured to:
determine respective parameters of one or more virtual cameras associated with the one or more 2D planes for a projection of the point cloud according to pretrained data.

18. The apparatus of claim 14, wherein the processing circuitry is configured to:
determine first parameters for voxelating the first object instance; and
voxelate the portion of the point cloud corresponding the first pixels in the pixel wise mask according to the first parameters.

19. The apparatus of claim 14, wherein the processing circuitry is configured to:
generate a scene graph associated with the point cloud based on the pixel wise mask, the scene graph including at least a first scene element identifying the first object instance.

20. The apparatus of claim 14, wherein the processing circuitry is configured to:
processing the point cloud with the pixel wise mask by at least one of a video based point cloud compression (V-PCC) scheme and/or a geometry based point cloud compression (G-PCC) scheme.
